(19) United States
(12) Patent Application Publication
(10) Pub. No.: US 2014/0333866 A1
(43) Pub. Date: Nov. 13, 2014

(54) LIQUID CRYSTAL DISPLAY AND THE FIXING STRUCTURE OF THE LIQUID CRYSTAL MODULE

(71) Applicant: Shenzhen China Star Optoelectronics Technology Co., Ltd., Shenzhen, Guangdong (CN)

(72) Inventors: Guofu Tang, Shenzhen City (CN); Dehua Li, Shenzhen City (CN)

(73) Assignee: Shenzhen China Star Optoelectronics Technology Co., Ltd., Shenzhen, Guangdong (CN)

(21) Appl. No.: 13/978,536

(22) PCT Filed: Jun. 24, 2013
(86) PCT No.: PCT/CN2013/077806

§ 371 Date: Jul. 6, 2013

(30) Foreign Application Priority Data
May 6, 2013 (CN) 201310163366.6

(51) Int. Cl. G02F 1/1333

(52) U.S. Cl. CPC G02F 1/133308; G02F 2001/133317
USPC 349/58

(57) ABSTRACT

A fixing structure for a liquid crystal structure and the liquid crystal display with the same are disclosed. The liquid crystal display includes a display module, a middle frame, a back frame, and a plurality of components. Portions of the component connect to a bottom surface of the liquid crystal module, and other portions of the component connect to the back frame by a fixing member. The liquid crystal module can be easily assembled by the fixing structure. In addition, by engaging the screw and the component in a feasible manner, the liquid crystal module and the back frame are feasibly assembled. The fixing structure not only prevents the display panel from being damaged, but also reduces the amount of the components needed in the assembly process.

### BACKGROUND OF THE INVENTION

1. Field of the Invention

The present disclosure relate to liquid crystal display (LCD) technology, and more particularly to LCD and the fixing structure of the liquid crystal module.

2. Discussion of the Related Art

FIG. 1 is a partial view of the structure of a conventional LCD. The liquid crystal display includes a display module 1, a front frame 2, a middle frame 3, and a back frame 4. The front frame 2 is for abutting against a backlight module 5 of the display module 1 to prevent a liquid crystal module 110 from being detached. With the technology revolution, the frameless LCD has become one current fashion trend. As shown in FIG. 2, a plastic member 6 is adhered to a glass substrate 7 of the liquid crystal module 110 via UV glue 9. A fixing component 8 is fixed on the back frame 4 by engaging the fixing component 8 with a square hole of the plastic member 6. In this way, the liquid crystal module is prevented from detached. However, the above configuration needs a lot of components and the assembly process is complex.

### SUMMARY

The object of the claimed invention is to provide a fixing structure for a liquid crystal module.

In one aspect, a fixing structure for a liquid crystal module includes: a liquid crystal module, a middle frame, a back frame and a plurality of components, portions of the component connect to a bottom surface of the liquid crystal module, and other portions of the component connect to the back frame by a fixing member.

Wherein the component includes a horizontal portion and an integrally formed vertical portion, a top surface of the horizontal portion adheres to the bottom surface of the liquid crystal module, and the vertical portion connects to the back frame.

Wherein the horizontal portion includes a recess formed on the top surface, and glue is arranged within the recess.

Wherein the glue is UV glue.

Wherein the glue is an epoxy adhesive.

Wherein the vertical portion includes an installation hole, and a screw hole is arranged on the corresponding back frame, the fixing member is a screw, the screw passes through the installation hole and engages with the screw hole, the screw includes a nut and a threaded rod, and a diameter of the installation hole is larger than the diameter of the threaded rod and is smaller than the diameter of the nut.

Wherein the installation hole is a counter bore, the screw is a staged screw, and a depth of the counter bore is smaller than a height of the threaded rod of the screw.

Wherein the middle frame includes a horizontal wall, and a buffering material is arranged between the liquid crystal module and a bearing surface of the horizontal wall of the middle frame.

Wherein the middle frame includes a horizontal wall, and a buffering material is arranged between the liquid crystal module and a bearing surface of the horizontal wall of the middle frame.

Wherein the middle frame includes a horizontal wall, and a buffering material is arranged between the liquid crystal module and a bearing surface of the horizontal wall of the middle frame.

Wherein the middle frame includes a horizontal wall, and a buffering material is arranged between the liquid crystal module and a bearing surface of the horizontal wall of the middle frame.

In another aspect, a liquid crystal display includes: a display module, a middle frame, a back frame, and a plurality of components; and wherein the display module includes a liquid crystal module and a backlight module, portions of the component connect to a bottom surface of the liquid crystal module, and other portions of the component connect to the back frame by a fixing member.

Wherein the component includes a horizontal portion and an integrally formed vertical portion, a top surface of the horizontal portion adheres to the bottom surface of the liquid crystal module, and the vertical portion connects to the back frame.

Wherein the horizontal portion includes a recess formed on the top surface, and glue is arranged within the recess.

Wherein the glue is UV glue.

Wherein the glue is an epoxy adhesive.

Wherein the vertical portion includes an installation hole, and a screw hole is arranged on the corresponding back frame, the fixing member is a screw, the screw passes through the installation hole and engages with the screw hole, the screw includes a nut and a threaded rod, and a diameter of the installation hole is larger than the diameter of the threaded rod and is smaller than the diameter of the nut.

Wherein the installation hole is a counter bore, the screw is a staged screw, and a depth of the counter bore is smaller than a height of the threaded rod of the screw.

Wherein the middle frame includes a horizontal wall, and a buffering material is arranged between the liquid crystal module and a bearing surface of the horizontal wall of the middle frame.

### BRIEF DESCRIPTION OF THE DRAWINGS

FIG. 1 is a partial view of a conventional liquid crystal display.

FIG. 2 is a partial view of a conventional liquid crystal display without the front frame.

FIG. 3 is a partial view of the liquid crystal display in accordance with one embodiment.

FIG. 4 is a partial view of the liquid crystal display in accordance with one embodiment.

FIG. 5 is a schematic view of one component in accordance with one embodiment.

FIG. 6 is a schematic view of the installation hole in accordance with one embodiment.

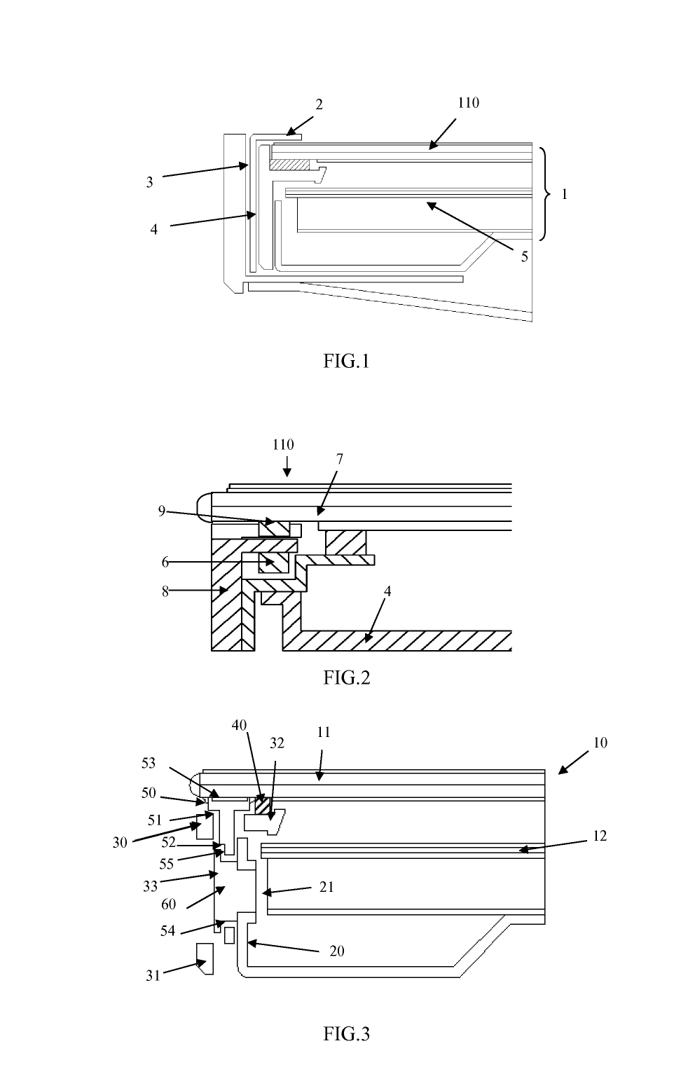

### DETAILED DESCRIPTION OF THE EMBODIMENTS

Embodiments of the invention will now be described more fully hereinafter with reference to the accompanying drawings, in which embodiments of the invention are shown.

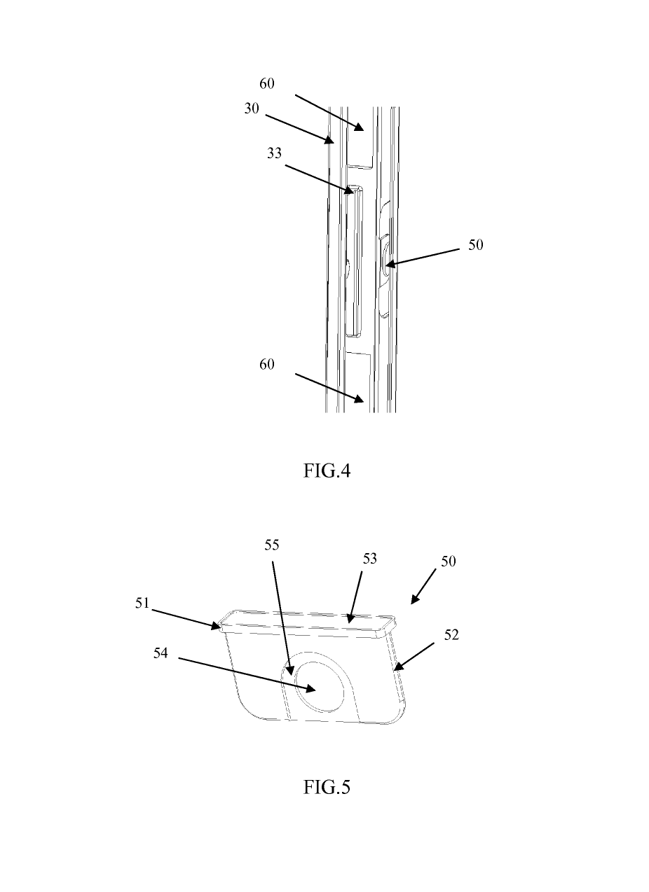

Referring to FIGS. 3, 4 and 5, the liquid crystal display includes a display module 10 and a back frame 20. The display module 10 includes a liquid crystal module 11, a backlight module 12, and a middle frame 30. The middle frame 30 includes a sidewall 31 and a horizontal wall 32 vertically connected to the sidewall 31. A buffering material 40 is arranged between the liquid crystal module 11 and a bearing surface of the horizontal wall 32 of the middle frame 30. As shown, the liquid crystal display further includes a plurality of components 50. Portions of the component 50 connect to a bottom surface of the liquid crystal module 11, and other portions of the component 50 connect to the back frame 20 by a fixing member 60. The components 50 are arranged in a periphery of the liquid crystal module 11 so as to connect the liquid crystal module 11 with the back frame 20.

The component 50 includes a horizontal portion 51 and an integrally formed vertical portion 52. A top surface of the horizontal portion 51 adheres to the bottom surface of the liquid crystal module 11. The vertical portion 52 connects to the back frame 20. The horizontal portion 51 includes a recess 53 formed on the top surface. Glue is arranged within the recess 53 to adhere the horizontal portion 51 onto the bottom surface of the liquid crystal module 11, which is the glass plate. In one embodiment, the glue may be the UV glue, or an epoxy adhesive. A faster manufacturing speed may be obtained as the UV glue is solidified by ultraviolet rays. The cost of the epoxy adhesive is low but the solidity speed is slow. The recess 53 prevents the glue from overflowed while the component 50 is pressed such that the polarizer within the liquid crystal module 11 is prevented from polluted.

The vertical portion 52 includes an installation hole 54, and a screw hole 21 is arranged on the corresponding back frame 20. A screw 60 passes through the installation hole 54 and engages with the screw hole 21. The screw 60 includes a nut and a threaded rod. The diameter of the installation hole 54 is larger than the diameter of the threaded rod and is smaller than the diameter of the nut. With the above assembling process, the component 50 is connected to the back frame 20.

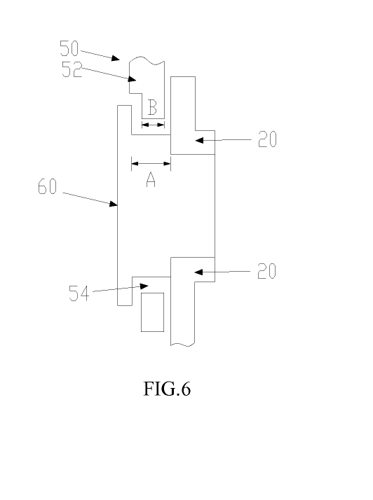

Referring to FIG. 6, the installation hole 54 is a counter bore, and the screw 60 is a staged screw. The depth of courter bore (as indicated by symbol “B”) is smaller than the height of the threaded rod of the screw 60 (as indicated by symbol “A”). A surface of the nut is within the counter bore, and the nut has not contacted with a platform 55 of the counter bore. The structure of the fixing structure is compact and the component 50 is feasibly assembled. The middle frame 30 includes a corresponding hole 33 to avoid the component 50. The dimension of the hole 33 is larger than the dimension of the vertical portion 52 of the component 30 such that the component 50 may be inserted into the middle frame 30 easily. Thus, the installation hole 54 of the component 50 may align with the screw hole 21 and the can be easily screwed.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A fixing structure for a liquid crystal module, comprising:
a liquid crystal module, a middle frame, a back frame and a plurality of components, portions of the component connect to a bottom surface of the liquid crystal module, and other portions of the component connect to the back frame by a fixing member.

2. The fixing structure as claimed in claim 1, wherein the component comprises a horizontal portion and an integrally formed vertical portion, a top surface of the horizontal portion adheres to the bottom surface of the liquid crystal module, and the vertical portion connects to the back frame.

3. The fixing structure as claimed in claim 2, wherein the horizontal portion comprises a recess formed on the top surface, and glue is arranged within the recess.

4. The fixing structure as claimed in claim 3, wherein the glue is UV glue.

5. The fixing structure as claimed in claim 3, wherein the glue is an epoxy adhesive.

6. The fixing structure as claimed in claim 2, wherein the vertical portion comprises an installation hole, and a screw hole is arranged on the corresponding back frame, the fixing member is a screw, the screw passes through the installation hole and engages with the screw hole, the screw comprises a nut and a threaded rod, and a diameter of the installation hole is larger than the diameter of the threaded rod and is smaller than the diameter of the nut.

7. The fixing structure as claimed in claim 6, wherein the installation hole is a counter bore, the screw is a staged screw, and a depth of the counter bore is smaller than a height of the threaded rod of the screw.

8. The fixing structure as claimed in claim 1, wherein the middle frame comprises a horizontal wall, and a buffering material is arranged between the liquid crystal module and a bearing surface of the horizontal wall of the middle frame.

9. The fixing structure as claimed in claim 2, wherein the middle frame comprises a horizontal wall, and a buffering material is arranged between the liquid crystal module and a bearing surface of the horizontal wall of the middle frame.

10. The fixing structure as claimed in claim 3, wherein the middle frame comprises a horizontal wall, and a buffering material is arranged between the liquid crystal module and a bearing surface of the horizontal wall of the middle frame.

11. The fixing structure as claimed in claim 6, wherein the middle frame comprises a horizontal wall, and a buffering material is arranged between the liquid crystal module and a bearing surface of the horizontal wall of the middle frame.

12. A liquid crystal display, comprising:
a display module, a middle frame , a back frame, and a plurality of components; and
wherein the display module comprises a liquid crystal module and a backlight module, portions of the component connect to a bottom surface of the liquid crystal module, and other portions of the component connect to the back frame by a fixing member.

13. The liquid crystal display as claimed in claim 12, wherein the component comprises a horizontal portion and an integrally formed vertical portion, a top surface of the horizontal portion adheres to the bottom surface of the liquid crystal module, and the vertical portion connects to the back frame.

14. The liquid crystal display as claimed in claim 13, wherein the horizontal portion comprises a recess formed on the top surface, and glue is arranged within the recess.

15. The liquid crystal display as claimed in claim 14, wherein the glue is UV glue.

16. The liquid crystal display as claimed in claim 14, wherein the glue is an epoxy adhesive.

17. The liquid crystal display as claimed in claim 12, wherein the vertical portion comprises an installation hole, and a screw hole is arranged on the corresponding back frame, the fixing member is a screw, the screw passes through the installation hole and engages with the screw hole, the screw comprises a nut and a threaded rod, and a diameter of the installation hole is larger than the diameter of the threaded rod and is smaller than the diameter of the nut.

18. The liquid crystal display as claimed in claim 12, wherein the installation hole is a counter bore, the screw is a staged screw, and a depth of the counter bore is smaller than a height of the threaded rod of the screw.

19. The liquid crystal display as claimed in claim 12, wherein the middle frame comprises a horizontal wall, and a buffering material is arranged between the liquid crystal module and a bearing surface of the horizontal wall of the middle frame.
